(19) United States
(12) Patent Application Publication
(10) Pub. No.: US 2004/0044692 A1
(43) Pub. Date: Mar. 4, 2004

(54) Collection storage system

(76) Inventor: Kevin Wade Jameson, Calgary (CA)

Correspondence Address: KEVIN JAMESON, 148 EDGEBANK PLACE NW, CALGARY, AB, T3A 4L4, CA

(21) Appl. No.: 10/227,848

(22) Filed: Aug. 27, 2002

(51) Int. Cl. G06F 17/30

(52) U.S. Cl. 707/200

(57) ABSTRACT

A Collection Storage System helps software developers to manage the storage and evolution of collections of computer files, by performing collection storage operations on collections and collection views. Collections are sets of computer files that can be manipulated as a set, rather than as individual files. Collection views are groups of related collection references that can be processed by human workers using a single operation on a single set of collection references, rather than by performing a series of individual operations on individual collections. In operation, a Collection Storage System receives collection storage operation requests from request originators. It performs the operations, often in the presence of collection information and collection view information that describes the target collections, views, and operations in detail. Finally, it returns operation results to the request originators. Collection Storage Systems improve human productivity by enabling people to perform collection-aware configuration management operations on collections and collection views, using advanced collection storage operations that were not previously known to the art.

### RELATED APPLICATIONS

Collection Information Manager, USPTO patent application Ser. No. 09/885078, Kevin W Jameson, Jun. 21, 2001.

Collection Knowledge System, USPTO patent application Ser. No. 09/885079, Kevin W Jameson, Jun. 21, 2001.

### FIELD OF INVENTION

This invention relates to software programs for managing the storage and evolution of software collections. Collection storage systems are similar to configuration management systems, except that collection storage systems are collection-aware, use collection information to perform powerful operations on collections, and improve the productivity of people and programs that work with collections of computer files. Collections are trees of computer files that can be manipulated as a set, rather than as individual files. Collections are comprised of collection specifier files and collection content files.

### BACKGROUND OF THE INVENTION

The present invention addresses the general problem of low productivity among human knowledge workers who use tedious manual procedures to work with collections of computer files. The most promising strategy for solving this productivity problem is to build automated computer systems to replace manual human effort.

One new software technology for improving productivity—software collections—enables computer programs to process collections of computer files more productively than previously possible. Collections are normal directory structures (“file folders”) of normal computer files, but they contain a special collection specifier file in the root directory of the collection. Collection specifier files specify, among other things, data types for collections. Computer programs can use collection data type values as lookup keys into databases to obtain detailed information about known collection data types. The detailed information obtained from the database enables computer programs to better understand the structure and content of the collections that they are processing. Having access to detailed information about collections enables programs to process collections in more intelligent ways than were previously possible

Collections are useful and practical because they make it easier for computer programs to manipulate the contents of collections. In one typical scenario, users invoke computer programs within a working directory contained within a collection directory structure. Computer programs recognize the location of the current collection by searching upwards for the special collection specifier file. Once programs know the physical location—the root directory—of the current collection, they can proceed to manipulate the collection to fulfill their processing functions.

Although collections are practical and useful, no systems exist for managing the storage and evolution of collections. This is significant practical limitation, because collection-aware configuration management systems could provide many useful collection storage operations to help improve the productivity of software developers who work with collections.

The present Collection Storage System invention contemplates a method for using collection information to perform collection storage operations on collections and collection views. Collection storage operations go beyond typical configuration management operations because collection storage operations work with collections and collection views, instead of with only trees of computer files. In addition, collection storage operations have the additional advantage of using detailed collection information to enable powerful manipulations of stored collections. Collection storage systems solve the problem of managing the storage and evolution of software collections by making it possible to work on collections and collection views, in the presence of detailed information about how to process those objects.

However, the collection storage system problem is somewhat complex, so it has several subproblems that require solutions. The following paragraphs characterize several of those problems.

The Collection Storage System Problem is one problem to solve. It is the problem of managing the storage and evolution of software collections and collection views. Solving this problem will enable people and programs to use detailed collection information to perform collection storage operations that were not previously possible using prior art techniques.

The Collection Storage System Problem has the following interesting aspects: an arbitrary number of collections, collection views, collection types, and collection storage operations may be involved; and operations may be dependent on collection type.

The Collection Target Selection Problem is another problem to solve. It is the problem of constructing a set of target collections to operate on, using collection information, collection view information, or other additional information to help construct a set of collections. Solving this problem will enable people to apply collection storage operations to whole sets of collections, including collection views, as easily as they can to individual collections.

The Collection Target Selection Problem has the following interesting aspects: targets may be individual collections, sets of collections, or collection views; targets may be selected by their types, by their contents, by their membership in collection views, or by their collection storage system attributes. Typical storage system attributes include locked status, owner, various timestamp properties, locations, names, or membership in particular hierarchical groups, views, or products.

The Collection Outside Operation Problem is another problem to solve. It is the problem of how to perform operations on collections within a collection storage system, but without using “internal” collection information or collection view information or any other information derived from the internal properties of collections. Solving this problem will enable people to perform collection storage operations that do not require knowledge of internal collection information, such as listing or deleting collections in the storage system.

The Collection Outside Operation Problem has the following interesting aspects: “outside” operations do not use information from inside the collection, such as collection types; outside operations typically use specific collection names, or apply to all collections (no names required).

The Collection Inside Operation Problem is another problem to solve. It is the problem of how to perform collection storage operations on collections within a collection storage system, using detailed collection information, collection view information, or other information derived from internal collection information. Solving this problem will enable people to perform advanced collection storage operations on collection and collection views, in the presence of detailed information about internal types, structures, contents, and properties of target collections.

The Collection Inside Operation Problem has the following interesting aspects: arbitrary inside operations are possible, although many collection storage operations are typical of configuration management systems; operations can be classified into non-collection-aware and collection-aware operations; collection-aware operations can apply to collections, collection views, or both; operations may require expansion of collection views; operations may use collection information, collection view information, or collection storage system information to fulfill their functions; operations can be primary operations that work directly with or on collections, or optional auxiliary operations that are performed according to the collection type of collections being processed by primary operations.

The Collection Type Auxiliary Operation Problem is another problem to solve. It is the problem of how to automatically perform auxiliary collection storage operations according to the types of collections being processed. Solving this problem will enable people to configure a collection storage system to automatically perform useful auxiliary operations on collections whenever a primary operation is performed on the collections. For example, a type-auxiliary operation could automatically rebuild changed collections containing program code, whenever the changed collections are checked into a collection storage system.

The Collection Type Auxiliary Operation Problem has the following interesting aspects: type-auxiliary operations are chosen according to collection types of target collections; type-auxiliary operations are non-critical operations that might be called “prologue,” “side-effect,” or “epilogue” operations; type-auxiliary operations are user-definable. Examples of auxiliary operations for a “checkin” primary operation include formatting code files, performing style checks, and adjusting carriage return (CRLF) and tab characters in incoming files.

The Collection User Auxiliary Operation Problem is another problem to solve. It is the problem of how to enable user-defined, collection-aware auxiliary operations for a collection storage system. Solving this problem will enable people to add their own operations to a collection storage system, thereby making the system extensible for new operations.

The Collection User Auxiliary Operation Problem has the following interesting aspects: user-auxiliary operations do not require knowledge of the internal structures or functions of the collection storage system; user-auxiliary operations are comprised of command sequences suitable for running in an external execution environment such as those provided by makefiles, shells, and other language interpreters; and user-auxiliary operations may or may not use collection information or collection view information. Examples of user-auxiliary operations include building collections or collection views, performing operations on individual collection files, or sending collection-oriented commands or notifications to other software systems.

The Platform Dependent Operation Problem is another problem to solve. It is the problem of how to represent platform-dependent auxiliary operations so that people can specialize auxiliary operations for various computing platforms.

The Platform Dependent Operation Problem has these interesting aspects: both type-auxiliary and user-auxiliary operations can be specialized by platform; platforms can be user-defined; platforms can use different tools and different command sequences to accomplish the same goals; an arbitrary number of platforms may be defined; and hierarchies of virtual platforms may be defined.

General Shortcomings of the Prior Art

The prior art contains no references that are relevant to the subject of the present invention. Even the related patent applications listed at the beginning of this document contain no mention of the Collection Storage System Problem. Accordingly, the following discussion is general in nature, because there are no specific works of prior art to discuss.

Prior art approaches, including prior art configuration management systems, lack support for collections. This is the largest limitation of all because it prevents people and programs from using high-level collection abstractions that can significantly improve productivity.

Prior art approaches lack support for collection views. This limitation prevents people from performing operations on sets of collections as easily as they can work with individual collections. Instead, people must process groups of collections by tediously processing each collection in the group individually, one at a time.

Prior art approaches lack support for dynamically calculating or selecting sets of target collections on which to perform collection storage operations. This limitation prevents people from performing operations on sets of collections that meet particular selection criteria.

Prior art approaches lack support for performing operations on collections without using internal collection information. This limitation prevents people performing fundamental collection storage operations on collections, such as listing collections, or deleting them from the storage system.

Prior art approaches lack support for performing advanced operations on collections with the help of detailed internal collection information. This limitation prevents people from performing operations that require knowledge of the internal type, structure, or contents of collections.

Prior art approaches lack support for automatically performing auxiliary operations on collections, according to the data types of the collections. This limitation restricts people to performing only primary operations directly on collections. If people want to perform auxiliary operations according to the type of collections, people are forced to remember collection types, command sequences for auxiliary operations, and even detailed control arguments for command sequences. These memorization requirements can easily exceed a normal person's memory capability, leading to low productivity and increased errors.

Prior art approaches lack support for user-defined auxiliary operations on collections. This limitation prevents people from defining useful auxiliary operations for managing collections stored in a collection storage system.

As can be seen from the above descriptions, prior art approaches lack the means to make it easy—or even possible—for people to conveniently manage collections and collection views in collection storage systems. Prior art approaches lack practical means for modelling collections of files, for modelling groups of related collections, for performing collection-oriented configuration management operations on collections with or without the use of detailed internal collection type information, and for automatically processing groups of collections.

In contrast, the present invention has none of these limitations, as the following disclosure will show.

### SUMMARY OF THE INVENTION

Collection Storage Systems improve the productivity of knowledge workers in the information industry by performing collection storage operations on collections and collection views that are stored within such systems. Collections are data-typed trees of computer files. Collection views are normal collections that contain lists of collection view member references to other collections that comprise the collection view.

Collection storage operations are comprised of primary operations and auxiliary operations. Primary operations perform major functions such as those found in configuration management systems, such as checkins and checkouts. Auxiliary operations perform minor operations that are prologue, side effect, or epilogue operations associated with primary operations. Type-auxiliary operations are applied to collections automatically, according to the collection type of collections being processed by primary operations. User-auxiliary operations are user-defined operations that extend the functional range of collection storage systems, and are not applied automatically.

In operation, Collection Storage Systems receive requests to perform collection storage operations, calculate sets of target collections for the operations, obtain collection information and collection view information for the targets, and perform primary and auxiliary operations using the obtained information.

Collection Storage Systems help people to manage and control the evolution of collections by providing people with means for performing collection-aware configuration management system operations on collections. By using detailed internal collection information, automated programs can perform complex collection-oriented operations that were not previously possible in the art, thereby improving the productivity of human knowledge workers.

### OBJECTS AND ADVANTAGES

The main object of the present Collection Storage System invention is to improve the productivity of human knowledge workers by enabling them to use collection storage operations to conveniently manage the storage and evolution of collections and collection views.

Another object is to solve the Collection Storage System Problem by providing means for managing the evolution of collections using collection storage operations. Collection storage operations are modeled after traditional configuration management system operations. But collection storage operations use inventive structures to obtain and use detailed internal collection information to perform advanced collection-oriented operations that were not previously possible using prior art techniques.

Another object is to provide means for managing the evolution of collection views using collection storage operations. Collection views enable people to perform collection storage operations on whole groups of collections as easily as performing operations on individual collections.

Another object is to solve the Collection Target Selection Problem by providing means for dynamically calculating and selecting sets of target collections, including collection views, to perform operations on.

Another object is to solve the Collection Outside Operation Problem by providing means for performing collection storage operations on collections without using detailed internal collection information, or information derived from internal collection information.

Another object is to solve the Collection Inside Operation Problem by providing means for performing advanced collection storage operations on collections, with the aid of detailed internal collection information derived from collection types and collection views.

Another object is to solve the Type-Auxiliary Operation Problem by providing means for automatically performing auxiliary collection storage operations on collections, wherein the auxiliary operations are automatically selected and performed according to the type of collections being processed.

Another object is to solve the User-Auxiliary Operation Problem by providing means for performing auxiliary collection storage operations on collections, wherein the auxiliary operations are user-defined and user-invoked as needs require.

Another object is to solve the Platform Dependent Operation Problem by providing means for representing and performing platform dependent auxiliary operations, thereby enabling people to specify and execute different operations for different computing platforms.

As can be seen from the objects above, Collection Storage Systems provide many useful and practical services to people and computer programs that work with collections.

Further advantages of the present Collection Storage System invention will become apparent from the drawings and disclosure that follow.

### BRIEF DESCRIPTION OF DRAWINGS

The following paragraphs introduce the drawings.

FIG. 1 shows a sample prior art file system folder from a typical personal computer.

FIG. 2 shows how a portion of the prior art folder in FIG. 1 has been converted into a collection 100 by the addition of a collection specifier file 102 named “cspec” FIG. 2 Line 5.

FIG. 3 shows the contents of a collection specifier file 102, implemented with a simple text file from a typical personal computer system.

FIG. 4 shows the structure of a full collection reference.

FIG. 5 shows several example collection references.

FIG. 6 shows a table of example shortcut references and their associated meanings.

FIG. 7 shows an example collection specifier containing two collection views. Each collection view contains multiple collection view member references, which are also known as typed collection references.

FIG. 8 shows the structure of a collection view member reference.

FIG. 9 shows several example collection view member references.

FIG. 10 shows an example name table for collection type names.

FIG. 11 shows an example collection type definition file for C program collections.

FIG. 12 shows an example name table for collection view member reference type names.

FIG. 13 shows an example collection view member reference type definition file for collection view member references of type “coll.”

FIG. 14 shows an example name table for collection view type names.

FIG. 15 shows an example collection view type definition file for collection views of type “view-default.”

FIG. 16 shows a simplified architecture for a prior art configuration management system that does not perform collection storage operations.

FIG. 17 shows a simplified architecture for a collection-aware configuration management system that can perform collection storage operations.

FIG. 18 shows a simplified architecture for a Collection Storage Operation Manager Means 120.

FIG. 19 shows a simplified algorithm for a Collection Storage Operation Manager Means 120.

FIG. 20 shows a simplified data structure for collection information.

FIG. 21 shows a simplified data structure for a collection view information.

FIG. 22 shows a name lookup table for “type-auxiliary” operations that are automatically applied according to collection type.

FIG. 23 shows a type-auxiliary definition file for collection types of “cf-program-c.”

FIG. 24 shows a type-auxiliary definition file for collection types of “cf-web-html.”

FIG. 25 shows a name lookup table for “user-auxiliary” user-defined operations that are manually applied by user invocation, regardless of collection type.

FIG. 26 shows a user-auxiliary definition file for a “format-me” auxiliary operation.

FIG. 27 shows a user-auxiliary definition file for a “spellcheck-me” auxiliary operation.

FIG. 28 shows a global ignore list of files that should be ignored while performing collection storage operations, thereby avoiding unwanted junk files in collection storage repositories.

FIG. 29 shows a name lookup table for platform dependent type-auxiliary operations.

FIG. 30 shows a platform dependent type-auxiliary definition file for a “win98” platform.

FIG. 31 shows a platform dependent type-auxiliary definition file for a “gnulinux” platform.

### LIST OF DRAWING REFERENCE NUMBERS

100 A collection formed from a prior art file folder

102 A collection specifier file

105 Local copies of authoritative files

106 Authoritative files in a CM repository

107 Local copies of authoritative collections

108 Authoritative collections in a CSS repository

110 A Configuration Management System Client

111 A Configuration Management System Server

112 A Do Non-Collection Operations Means

115 A Collection Storage System Client Means

116 A Collection Storage System Server Means

120 A Collection Storage Operation Manager Means

121 A Perform Outside Operations Means

122 A Select Target Collections Means

123 A Get Collection Storage Operation Information Means

124 A Get Collection Information Means

125 A Get Collection View Information Means

126 A Perform Inside Operations Means

127 A Perform Type Auxiliary Operations Means

128 A Perform User Auxiliary Operations Means

### DETAILED DESCRIPTION

The following disclosure describes the present Collection Storage System invention with reference to a preferred file system implementation of the invention. However, the invention is not limited to any particular computer architecture, operating system, file system, database, or other software implementation. The descriptions that follow should be considered as implementation examples only and not as limitations of the invention.

Introduction to Collections

Collections are sets of computer files that can be manipulated as a set, rather than as individual files. Collection information is comprised of three major parts: (1) a collection specifier that contains information—such as a collection data type—about a collection instance, (2) a collection type definition in a knowledge base that contains information about how to process all collections of a particular type, and (3) optional collection content in the form of arbitrary computer files that belong to a collection.

Collection specifiers contain information about a collection instance. For example, collection specifiers may define such things as the collection type, a text summary description of the collection, collection content members, derivable output products, collection processing information such as process parallelism limits, special collection processing steps, and program option overrides for programs that manipulate collections. Collection specifiers are typically implemented as simple key-value pairs in text files or database tables.

Collection type definitions are user-defined sets of attributes that are stored in a central knowledge base so they can be shared among multiple collections. In practice, collection specifiers contain collection type indicators that reference detailed collection type definitions that are externally stored and shared among all collections of a particular type. Collection type definitions typically define such things as collection types, product types, file types, action types, administrative policy preferences, and other information that is useful to application programs for understanding and processing collections.

Collection content is the set of all files and directories that are members of the collection. By convention, all files and directories recursively located within a collection subtree are collection content members. In addition, collection specifiers can contain collection content directives that add further files to the collection membership. Collection content is also called collection membership.

Collection is a term that refers to the union of a collection specifier and a set of collection content.

Collection information is a term that refers to the union of collection specifier information, collection type definition information, and collection content information.

Collections have many practical applications in the technical arts. They make it convenient for programs and human knowledge workers to manipulate whole sets of computer files where only individual files could be manipulated before. They make it possible to manipulate collections according to standard processing policies that are part of the collection type definition in a database.

Collection Representations

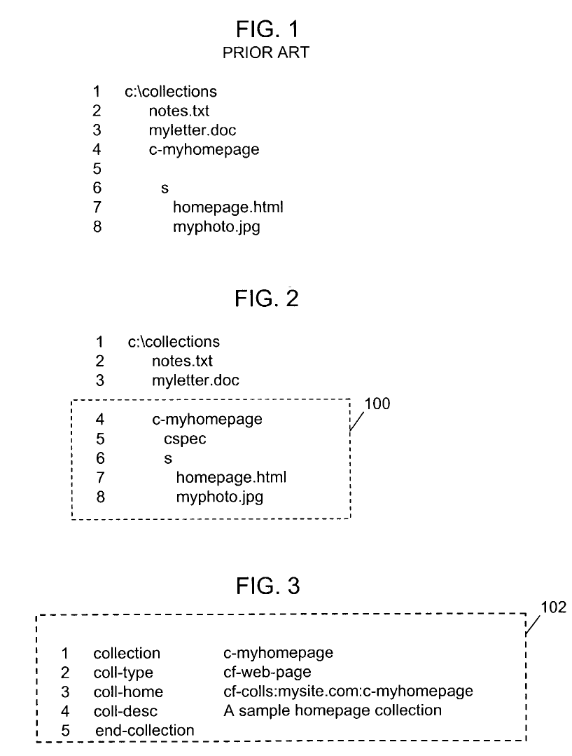

FIGS. 1-3 show a preferred embodiment of collections for a typical personal computer.

FIG. 1 shows a sample prior art file system folder from a typical personal computer.

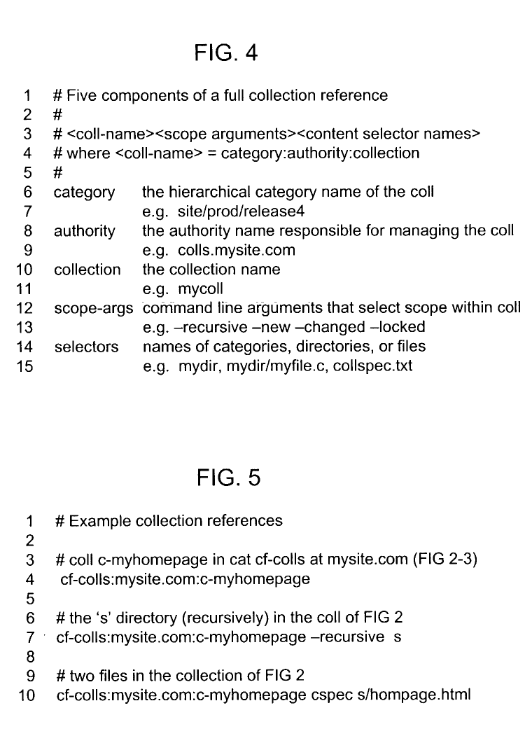

FIG. 2 shows the prior art folder of FIG. 1, but with a portion of the folder converted into a collection 100 by the addition of a collection specifier file FIG. 2 Line 5 named “cspec”. In this example, the collection contents FIG. 2 Lines 4-8 of collection 100 are defined by two implicit policies of a preferred implementation.

First is a policy to specify that the root directory of a collection is a directory that contains a collection specifier file. In this example, the root directory of a collection 100 is a directory named “c-myhomepage” FIG. 2 Line 4, which in turn contains a collection specifier file 102 named “cspec” FIG. 2 Line 5.

Second is a policy to specify that all files and directories in and below the root directory of a collection are part of the collection content. Therefore directory “s” FIG. 2 Line 6, file “homepage.html” FIG. 2 Line 7, and file “myphoto.jpg” FIG. 2 Line 8 are part of the collection content for collection 100.

FIG. 3 shows an example collection specifier file 102, FIG. 2 Line 5, for use on a typical personal computer file system.

Introduction to Collection References

Collections are useful and practical software containers for computer files because they make it easier to work with sets of related computer files. Programs can work with collections directly if the programs are invoked within the collection directory structure, but programs cannot reference collections from outside a collection without a proper means for doing so. The restriction of always being forced to work on collections from within their directory structures is a significant limitation in processing flexibility.

Collection references overcome this limitation by making it possible to conveniently refer to collections from outside a collection directory structure. Several different kinds of references are possible, as the following discussion shows. The discussion starts with simple expressions and builds up to collection references.

Expressions are comprised of sequences of characters. Expressions have no meaning until a human or program interprets them with respect to a set of interpretation rules. For example, numeric expressions are comprised of numbers. Alphabetic expressions are comprised of letters. Alphanumeric expressions are comprised of both letters and numbers.

References are comprised of expressions that refer to something when humans or programs interpret the references with respect to a set of interpretation rules. For convenience, humans often name or classify references according to (1) the syntactic form of the reference or to (2) the target of the reference (the referent). Examples of naming references after their syntactic form include numeric references, pointer references, HTTP URL references, and FTP references. Examples of naming references after the referents that are pointed to include document references, file references, and collection references.

Collection References are comprised of expressions that, when interpreted, refer to collections. Collection references can refer to collections in three ways: by name, by location, or by internal properties such as type or content.

References to collections by name only have meaning within collection namespaces that are defined by humans or application programs that manage entries in the namespace. For example, a configuration management system that “understood” collections would specify a particular syntax for referring to collections by name within the managed namespace. One example of a collection name syntax is “<category>: <authority>: <collection>.” The category part is a hierarchical expression that categorizes collections within the collection namespace. The authority part is the name of an authority (usually an Internet hostname such as foo.bar.com) that manages the collection namespace. The collection part is the name of a collection, within the category, within a collection namespace, that is managed by an authority.

References to collections by location are references to file folders or directories in computer file systems. This method works because collections are normally stored in file folders or hierarchical directory structures in computer file systems. The content of a directory structure, namely the presence of a collection specifier, ultimately determines whether the directory actually contains a collection.

References to collections by properties are search expressions that programs use to find and select interesting collections for processing. For example, a searcher might want to refer to all collections of a particular collection type within a collection namespace or within a computer file system.

Shortcut Collection References are short-form references that save people typing effort. The main idea of shortcut references is that people can save typing by omitting various parts of normal collection references. Application programs fill in the missing parts, using default values from the current local working collection, or from default values specified by the application program. Shortcut collection references are very useful in practice because they reduce typing effort and reduce knowledge burdens on human users. People don't have to remember details of long collection references. They can use easy-to-remember shortcut references instead.

Collection Reference Representations

FIGS. 4-6 show several formats for collection references and shortcut references.

FIG. 4 shows the structure of a complete collection reference. FIG. 4 Line 3 shows three main components of a preferred implementation of a complete collection reference—a collection name, a set of scoping arguments, and a set of content selector arguments.

A collection name is comprised of three parts—a category name, an authority name, and a collection name. A category name is a hierarchically structured name that groups related collections into categories, just as directory folders group related computer files into directories. An authority name is the name of the authority that is responsible for managing a collection. In practice, an authority name is an Internet Domain Name of a host computer that executes a server program for managing collections. A collection name is the name of a collection.

A collection reference scoping argument modifies a collection reference to refer to particular portions of a whole collection. For example, a “-recursive” scoping argument indicates that a reference should recursively include all directories and filenames below the recursion starting directory. Other examples of scoping arguments include “-new,” “-changed,” “-old,” “-local,” “-remote, ” and “-locked.” These arguments limit the scope of a collection reference to particular directories and filenames by comparing a local collection copy with a remote authoritative collection copy. Scoping arguments help people to reference just the collection directories and files that interest them.

A collection reference content selector is a particular category, directory, or filename that limits a collection reference to include particular named categories, directories, or filenames. Whereas scoping arguments use properties of collection elements (e.g. new, locked, changed) to limit collection references, content selectors use explicit names of collection content members to limit collection references.

FIG. 5 shows several example collection references that use scoping arguments and content selector arguments. Lines 3-4 show a normal “whole collection” reference for the collection shown in FIG. 2. Lines 6-7 show a collection reference that is limited by scoping and selector arguments to a recursive subtree of the collection that is rooted at the “s” directory shown in FIG. 2 Line 6. Lines 9-10 show a collection reference that is limited by selector arguments to the “cspec” file FIG. 2 Line 5 and to the “s/homepage.html” file FIG. 2 Line 7.

Shortcut Collection References

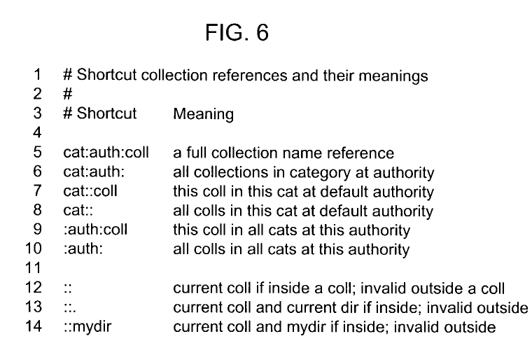

FIG. 6 shows a table of shortcut collection references and their meanings. A shortcut collection reference omits one or more parts of a normal three-part collection name. For example, FIG. 6 Line 6 shows a shortcut reference that omits the third component of a collection name, and thereby refers to “all collections” in the specified category at the specified authority.

Shortcut collection references are very useful in practice. They save typing. They reduce reference errors. They provide increased power and flexibility for referencing individual and multiple categories of collections, authorities, and individual collections. In fact, shortcut collection references have more referential power than complete three-part collection names. This is because complete collection names must provide specific values for a category and a collection, and so cannot refer to all categories, or all collections.

Local and Remote Collection References

FIG. 6 also shows both local and remote collection references. Lines 12-14 show local collection references, and Lines 5-10 show remote collection references.

Local Collection References refer to the current working collection. A current working collection for a program that is making a local collection reference is defined to contain the working directory of the program. Local collection references have no meaning, and are invalid, if no collection contains the working directory of a computer program that is making a local collection reference. In the examples presented in this disclosure, local collection references begin with a double colon “::” as shown in FIG. 6 Lines 12-14. Other syntaxes are also possible.

Remote Collection References do not depend on a program's current working directory being within a collection directory structure. A valid remote collection reference can be made from within any file system directory, whether inside or outside of a collection directory structure. In the examples presented in this disclosure, remote collection references do not start with a double colon “::” character sequence. Other syntaxes are also possible.

FIG. 6 Line 14 shows a reference that could be construed as a remote reference that means “all categories at all authorities that contain a collection called ‘dir’.” This interpretation is legitimate because it is in accordance with the conventions that have been presented above for remote collection references. But that is not the meaning used in this disclosure. Instead, it is more advantageous to use this particular syntax (“::dir”) to refer to local partial collections, for two reasons. First, this syntax is rarely, if ever, used for remote references in practice. Second, the double colon at, the beginning of the reference makes it look like a local reference, so it would cause confusion among users if it were used as a remote reference. For these reasons, preferred implementations treat the syntax (“::dir”) as a local collection reference.

Keep in mind that the interpretation of any collection reference is ultimately determined by the implementation policies of the computer program that interprets the reference. This is why other syntaxes are also possible. For example, an application program could specify that local collection references should begin with a double sequence of a non-colon character such as “x.” Then the three shortcut local references shown in FIG. 6 Lines 12-14 would be “xx” “xx<dot>” and “xxdir” (where <dot> means a period). Or a slash could be used, giving “//” “//<dot>” and “//dir.” This disclosure, which explains a preferred implementation, uses double colons for shortcut local collection references, to maintain a consistent look among all collection references. Other implementations are also possible.

Introduction To Collection Views

Collections are useful for representing sets of computer files, and collection references are useful for referring to individual collections. But neither collections nor collection references are useful for referencing sets of collections. This is a significant limitation, because people often want to work with sets of collections, just as they want to work with sets of computer files.

Collection views solve the problem of referencing sets of collections by making it possible for one collection to represent sets of other collections. Collection views enable people and programs to perform operations on whole sets of collections as easily as they can perform operations on single collections.

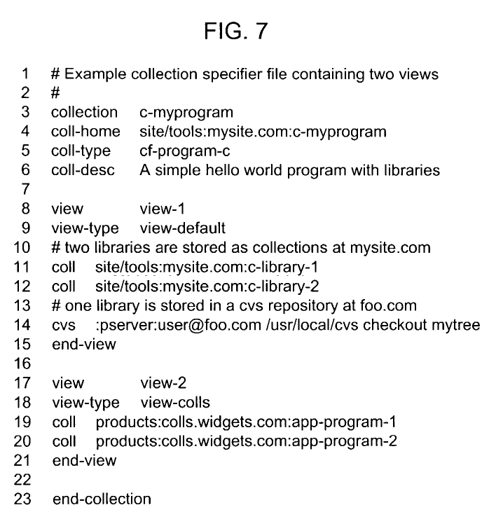

Collection Views are lists of references to other collections. FIG. 7 Lines 17-21 show an example collection view. Collection views are comprised of a view name, a view type, and a list of view member references. A collection view name is a user-defined value that provides a means for referring to the view. A collection view type is a type indicator that associates a view with a particular set of attribute-value pairs that specify useful information about all views of a particular view type. Each unique set of attribute-value pairs is called a collection view type definition. A collection view member reference is a reference that is part of the contents of a collection view.

Collection View Members are physical collections or source trees that are targets of collection view member references contained in collection views. FIG. 2 shows a collection that could be a collection view member. Collection view members are pointed to by collection view member references.

Collection View Member References are references that point to collection view members. FIG. 7 Line 19 shows a collection view member reference. Collection view member references are comprised of collection view member reference types and collection view member reference expressions.

Collection View Member Reference Types are type indicators that associate view member references with particular sets of attribute-value pairs that specify useful information about all view member references of a particular collection view member reference type. Each unique set of attribute-value pairs is called a collection view member reference type definition. FIG. 7 Line 18 Column 2 shows a collection view member type indicator.

Collection View Member Reference Expressions identify particular collections or source trees of computer files that comprise a collection view member. FIG. 7 Line 19 Column 2 shows one example of a collection view member reference expression. FIG. 7 Line 14 Columns 2-N shows a second example of a collection view member reference expression. Application programs use view member reference expressions to access or manipulate view member collections or source trees.

Collection view member reference expressions can take many syntactic forms, corresponding to how the physical collections or source trees are stored. For example, view member reference expressions can be collection reference expressions that name collections, expressions that name modules stored in configuration management systems, URL (Uniform Resource Locator) expressions that point to directories stored on remote servers, or any other kinds of expressions that can be used to identify source trees of computer files that comprise collection view members.

Collection View Representations

FIGS. 7-9 illustrate the structure and format of collection views.

FIG. 7 shows an example collection specifier that contains two collection views. Lines 8-15 show a first view named “view-1” and Lines 17-21 show a second view named “view-2.”

FIG. 7 Lines 17-21 show the structure of a collection view. Line 17 begins the view and specifies the collection view name. Line 18 specifies the collection view type, which associates the view with a set of attribute-value pairs defined in a corresponding collection view type definition. Lines 19-20 specify two collection view member references. Line 21 terminates the collection view.

FIG. 7 Line 19 shows the structure of a collection view member reference. Column 1 specifies a collection view member reference type, which associates a view member reference expression Column 2 with a set of attribute-value pairs defined in a corresponding collection view member reference type definition: Columns 2-N specify a collection view member reference expression and optional arguments.

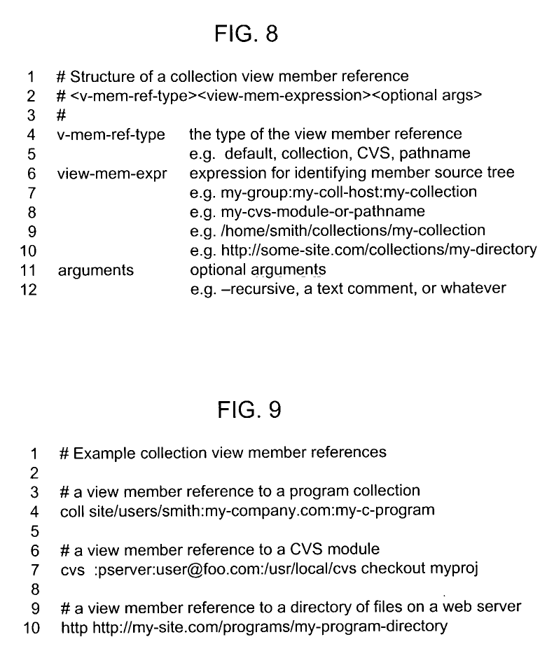

FIG. 8 shows the formal structure of a collection view member reference. Line 2 specifies that a collection view member reference is comprised of three parts—a view member reference type, a view member reference expression, and optional arguments. The functions of these three parts were described in the previous paragraph.

FIG. 9 shows several example collection view member references that contain different view member types and view member reference expression syntaxes.

Introduction to Types and Decorations

Collections, collection references, and collection views are all useful data structures for holding information, but none of them provides information to help programs process the contents of data structures in smart ways.

A better approach to smart processing of these data structures is to provide programs with a separate source of information that contains detailed information about the data structures and the contents therein. That way, programs can read the separate information to easily understand how to process the information content of the three data structures. Types and decorations are a means for providing the separate information.

Types are comprised of a type indicator and a type definition. A type definition contains sets of attribute-value pairs.

Decorations are attribute-value pairs from a type definition. When a collection, collection reference, or collection view is combined with a set of attribute-values pairs from a type definition, we say that it is “decorated.”

Programs usually decorate data structures using the following process. First, programs obtain a collection, collection reference, or collection view data structure to decorate. Second, programs obtain a type indicator for, or from, the data structure. Third, programs use the type indicator to obtain type definition information (decorations) corresponding to the type indicator. Fourth, programs decorate the original data structure by associating it with the attribute-value pairs (decorations) retrieved from the type definition.

Programs determine type indicators in two ways. If a type indicator is part of the original data structure, as is the case for collections and collection views, programs retrieve the type indicator from the data structure. If a type indicator is not part of the original data structure, as is the case with collection references, then programs must calculate a type indicator using other means. Perhaps programs analyze the contents of the data structure to calculate a type, or perhaps they retrieve an external, but associated, type indicator that is not part of the original data structure.

The use of types and decorations gives rise to several new classifications of collection, collection reference, and collection view data structures. Now we can have typed and decorated versions of each data structure. The following paragraphs define each new combination.

Typed Data Structures

Typed Collections are the same as normal collections because normal collections already contain a type indicator as part of the collection data structure. The terms “collection” and “typed collection” are synonymous. FIG. 3 Line 2 Column 2 shows a collection type indicator within a collection specifier file.

Typed Collection References are comprised of an external type indicator and a normal collection reference. FIG. 7 Line 19 shows a typed collection reference. Column 1 specifies a collection reference type and Column 2 specifies a collection reference. Typed collection references are called collection view member references when they appear within collection views.

Typed Collection Views are the same as normal collection views because normal collection views already contain a type indicator as part of the collection view data structure. The terms “collection view” and “typed collection view” are synonymous. FIG. 7 Line 18 Column 2 shows a collection view type indicator within a collection view within a collection specifier.

Decorated Data Structures

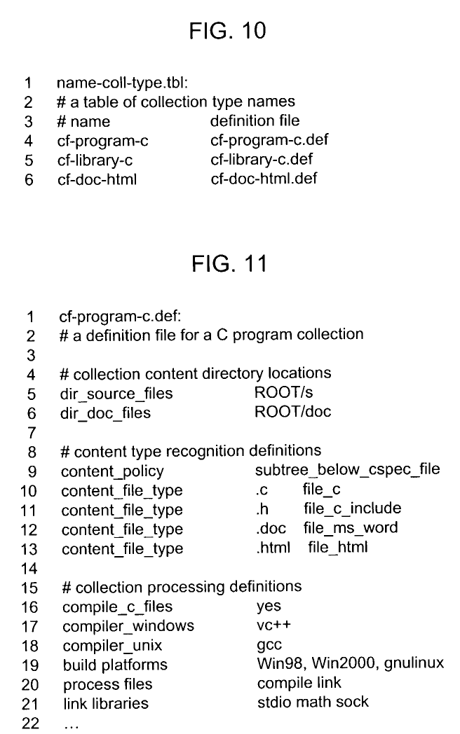

Decorated Collections are comprised of a collection and decorations in the form of attribute-value pairs from a collection type definition. Decorations specify interesting properties shared by all collections of a particular collection type. Decorated collections are the most useful type of collections to application programs, because they contain decorations that help to tell application programs how to process the decorated collections. FIG. 10 shows an example lookup name table of collection type names. FIG. 11 shows an example collection type definition (decorations). In operation, application programs look up type names in a name table FIG. 10 Column 1 to obtain names of corresponding type definition files FIG. 10 Column 2.

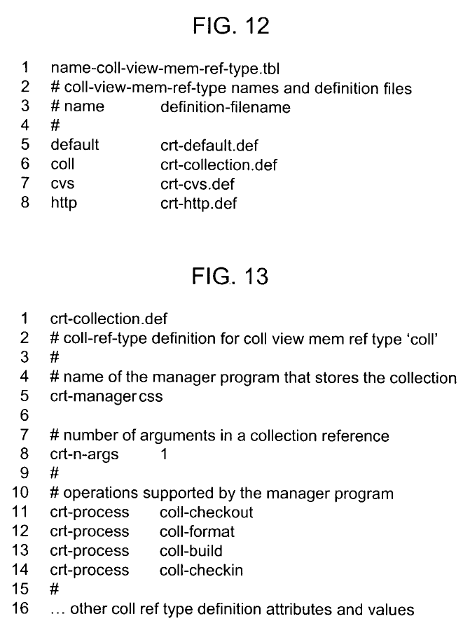

Decorated Collection References are comprised of a collection reference and decorations in the form of attribute-value pairs from a collection reference type definition. Decorations specify interesting properties shared by all collection references of a particular collection reference type. Decorated collection references are the most useful type of collection references for application programs, because the decorations help to tell application programs how to process the decorated collection references. For example, suppose that some attribute-value pairs specified the name of a collection namespace, and how to contact the authority for that namespace. Then an application program could use those attribute-value pairs to contact the authority responsible for the namespace. FIG. 12 shows an example lookup name table of collection view member reference type names. FIG. 13 shows an example collection view member reference type definition (decorations).

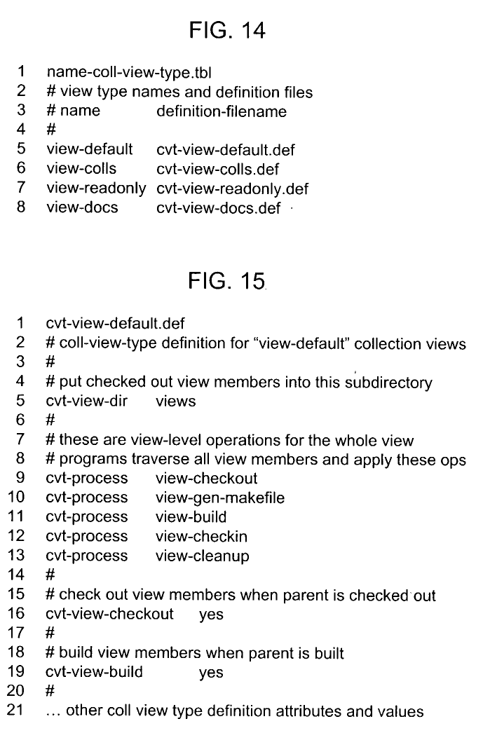

Decorated Collection Views are comprised of (1) a collection view, (2) decorations that specify properties of the collection view, and (3) decorations that specify interesting properties of each of the typed collection references in the view. Decorated collection views are the most useful kind of collection views for application programs because they contain detailed information that help to tell the application programs how to process decorated collection views. FIG. 14 shows an example lookup table of collection view type names. FIG. 15 shows an example collection view type definition (decorations).

Each of the normal, typed, and decorated forms listed above is useful for particular purposes. The normal form of a data structure is efficient for holding the core data content of interest. The typed form of a data structure is most convenient for humans, because it replaces long lists of decorations with a single type indicator token. Finally, the decorated form of a data structure is most convenient for application programs, because it contains additional useful information that helps programs to process the decorated data structures in more useful and more appropriate ways.

Conversion Among Normal, Typed, and Decorated Forms

Since each of the normal, typed, and decorated forms is useful for particular purposes, it is also useful for application programs to convert back and forth among the various representations.

Collection Information Managers are programs that convert typed collections into decorated collections. Recall that typed collections are the same as normal collections because normal collections already contain collection type indicators. Collection information managers produce “collection information” that represents decorated collections.

Collection Information is comprised of a collection specifier, collection type definition information, and collection content information.

Collection Shortcut Expanders are programs that convert shortcut collection references into complete collection references.

Collection View Expanders are programs that convert typed collection views into decorated collection views. Recall that typed collection views are the same as normal collection views because normal collection views already contain collection view types. Collection Storage Systems produce “collection view information” that represents decorated collection views.

Collection View Information is comprised of a collection view, including a collection view type and a list of collection view member references, and collection view type definition information and a list of corresponding collection view member reference type definition information. Collection view information is nearly equivalent to a list of decorated collection references, with the addition of collection view type definition information.

Collection Enabled Program Architectures

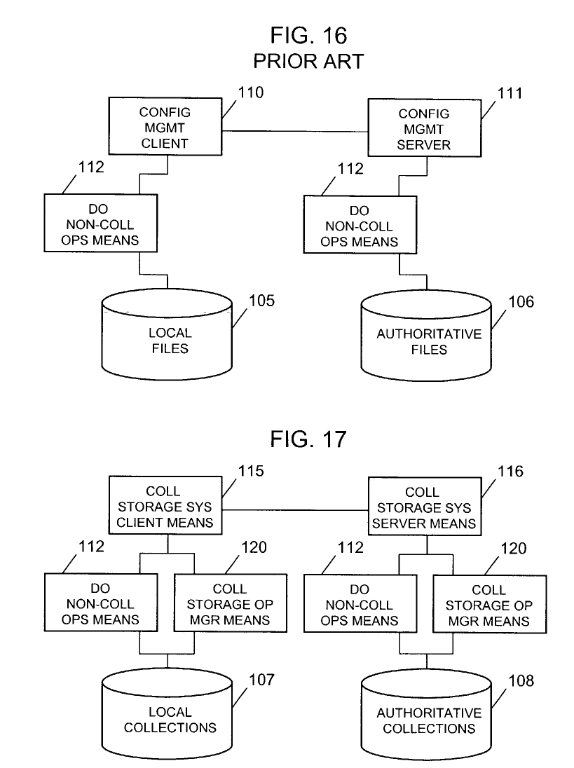

FIGS. 16-17 show example collection enabled application program architectures. The term “collection enabled” denotes an ability to work with collections and collection views. For example, collection enabled programs can recognize collections, read collection specifier files, and obtain collection information and collection view information from a database. Collection enabled programs can process collection contents and collection views according to policies defined by collection type definitions and collection view type definitions.

FIG. 16 shows how a prior art configuration management client 110 and server 111 work with local copies 105 of authoritative files from a repository of authoritative files 106. The prior art configuration management (CM) system performs typical CM operations on the files using a Do Non-Collection Operations Means 112, including list, checkin, checkout, lock, merge, and difference. The prior art CM system is not collection enabled, and does not perform collection-oriented operations.

FIG. 17 shows how a collection enabled Collection Storage System Client Means 115 and a Collection Storage System Server Means 116 work with local collections 107 that are copies of authoritative collections from a repository of authoritative collections 108. A collection storage system performs collection storage operations on collections using both a Do Non-Collection Operations Means 112 and a Collection Storage Operations Manager Means 120.

Collection Storage Systems are collection-aware configuration management systems that help to manage the evolution of computer files, including collections and collection views. Collection storage systems enable people to perform collection storage operations on files, directories, collections, and collection views that are managed by the system.

Collection Storage Operations are comprised of typical CM system operations and collection-aware operations. Collection-aware operations use novel inventive structures to extend the scope and functionality of prior art configuration management systems to work with collections and collection views.

One example of a typical collection storage operation (CSO) performed by a collection storage system is to list a set of collections that are stored within the system. Another example is to check out a whole collection from the system. Another example is to check out and expand a whole collection view.

Collection storage operations solve several typical problems that are faced by software developers, who frequently must work with multiple source trees (collections) that comprise software applications. Without collections, collection views, and collection storage operations, developers must identify and operate on individual files or directories. But with a collection storage system, developers can increase their productivity by performing higher-level, collection-oriented operations that work with whole collections or whole collection views.

Collection Storage Systems

The main goal of the present invention is to provide collection-oriented configuration management operations to application programs, so that the programs can usefully manipulate collection in productive ways that were not previously possible. For example, an existing prior art configuration management system could use the present invention to add collection-oriented functionality to the prior art system.

In operation, an application program invokes a Collection Storage Operation Manager Means 120 to perform collection storage operations on collections and collection views.

Having summarized the architecture of collection storage systems FIG. 17 and some typical collection storage operations, we now describe a preferred embodiment of the present Collection Storage System invention.

Module Collection Storage Operation Manager Means

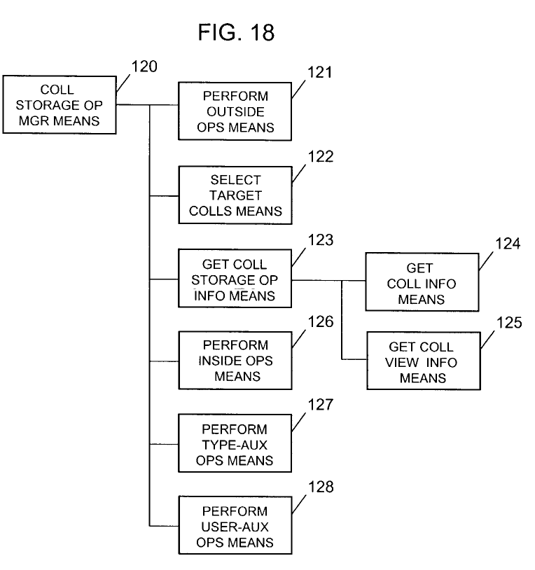

FIG. 18 shows a simplified architecture for a Collection Storage Operation Means 120.

Module Perform Outside Operations Means 121 performs collection storage operations that do not require the use of “inside” collection information or collection view information.

Module Select Target Collections Means 122 determines a set of collections on which to perform collection storage operations.

Module Get Collection Storage Operation Information Means 123 calls subordinate modules to obtain collection information and collection view information to support collection storage operations.

Module Get Collection Information Means 124 obtains collection information and returns it to its caller module in a collection information data structure such as shown in FIG. 20.

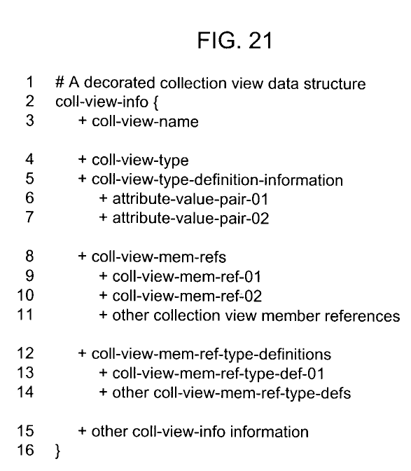

Module Get Collection View Information Means 125 obtains collection view information and returns it to its caller module in a collection view information data structure such as shown in FIG. 21.

Module Perform Inside Operations Means 126 performs collection storage operations that require the use of “inside” collection information or collection view information.

Module Perform Type Auxiliary Operations Means 127 performs auxiliary collection storage operations that are automatically applied to target collections according to their collection types. This enables people to consistently apply automatic auxiliary operations to target collections based on their collection type, without having to remember to apply the operations, or to remember command sequences.

Module Perform User Auxiliary Operations Means 128 performs user-defined auxiliary operations on target collections. User-defined operations enable people to extend the functionality of a collection storage system without having to modify the internal code of the system.

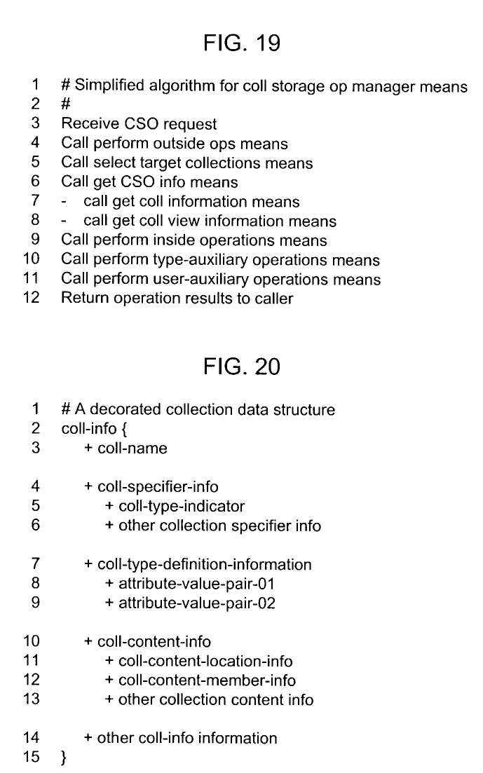

FIG. 19 shows a simplified algorithm for a Collection Storage Operation Manager Means 120.

In operation, a Collection Storage Operation Manager Means 120 receives a collection storage operation (CSO) request from a calling module such as Collection Storage System Server Means 116. The request specifies a set of target collections to work on, and collection storage operations to perform. The CSO Manager Means 120 proceeds according to the algorithm of FIG. 19, calling subordinate modules to perform various subtasks.

Module Perform Outside Operations Means

If the requested operation is an outside operation such as “list” or “delete,” and if there is no need to select target collections using inside collection information, there is no need to obtain inside collection information. Instead, outside operations are performed directly by module Perform Outside Operations Means 121, and results are returned to the CSO Manager Means 120, to pass on to the original CSO requester.

If the requested operation is an outside operation that requires dynamic calculation or selection of a target collection set, then Perform Outside Operations Means 121 cannot be called alone. Modules Select Target Collections Means 122 and Get Collection Storage Operations Information Means 123 must be called to provide selection and information services, respectively, to help fulfill the function of Perform Outside Operations Means 121.

Module Select Target Collections Means

Next, Module Select Target Collections Means 122 calculates a set of target collections for the operation. If the calculation does not require inside collection storage information, the calculation is performed and the algorithm continues. But if the calculation does require inside collection storage information, Get Collection Storage Operations Information Means 123 must be called to provide the necessary collection information and collection view information.

Module Get Collection Storage Operations Means

Module Get Collection Storage Operations Information Means 123 uses subordinate modules to obtain detailed information about the target collections that are being processed.

Module Get Collection Information Means 124 obtains collection information, which is comprised of collection specifier information, collection type definition, and collection content information. FIG. 20 shows a simplified data structure that could store obtained collection information.

Module Get Collection View Information Means 125 obtains collection view information, which is comprised of a collection view, including a collection view type and a list of collection view member references, and collection view type definition information and a list of corresponding collection view member reference type definition information. FIG. 21 shows a simplified data structure that could store obtained collection view information.

At this point in the algorithm, we can assert that a set of target collections has been calculated, and collection storage information has been obtained. Normal inside operations and auxiliary operations can now be performed in the presence of detailed information about collections, collection views, and the collection storage operations that are to be performed.

Module Perform Inside Operations Means

Continuing, Perform Inside Operations Means 126 carries out collection-aware collection storage operations on the set of target collections, using the collection storage operation information obtained by Get Collection Storage Operations Information Means 123. Inside operations use their detailed knowledge of collection types to perform advanced, collection-aware collection storage operations that improve the productivity of software developers. Normal configuration management systems cannot perform collection-aware inside operations because they lack the inventive structures required to understand and work with collections.

Module Perform Type-Auxiliary Operations Means

Module Perform Type-Auxiliary Operations Means 127 continues the algorithm by performing type-auxiliary operations according to the collection types of target collections. These operations enable people to tell collection storage systems to perform useful prologue or epilogue operations on target collections, thereby relieving software developers of the responsibility of applying the same operations to all target collections in a consistent, error-free manner.

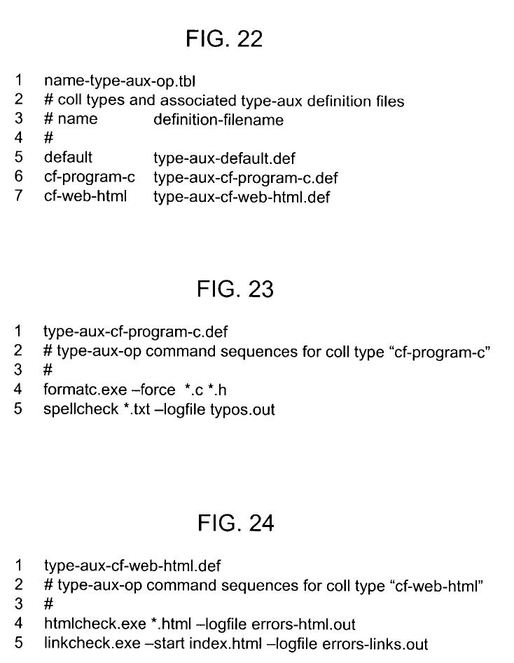

FIG. 22 shows a name lookup table for “type-auxiliary” operations that are automatically applied to target collections according to collection type. Suppose that a target collection has a collection type of “cf-program-c” that indicates a collection containing program code written in the C programming language. Perform Type-Auxiliary Operations Means 127 looks up the collection type “cf-program-c” in FIG. 22 Column 1 Line 6, to obtain a definition filename “type-aux-cf-program-c.def” from Column 2.

FIG. 23 shows a type-auxiliary definition file for collections of type “cf-program-c.” Line 4 shows a command line that invokes a program to format all C program code and C header files. Line 5 shows a command line that invokes a program to spell check all text files. In operation, Perform Type-Auxiliary Operations Means 127 automatically executes these commands on target collections of type “cf-program-c,” thereby automatically formatting and spell checking files in the target collections.

FIG. 24 shows a type-auxiliary definition file for collections of type “cf-web-html.” Line 4 shows a command line that invokes a program for checking HTML syntax of web page files. Line 5 shows a command line that invokes a program for finding broken links in a tree of HTML web pages, where the tree is rooted at a file called “index.html.” In operation, Perform Type-Auxiliary Operations Means 127 automatically executes these commands on target collections of type “cfweb-html,” thereby automatically checking for syntax errors and broken links in HTML web pages in the target collections.

FIGS. 18-19 show Perform Type-Auxiliary Operations Means 127 as appearing after Perform Inside Operations Means 127 in both pictorial and algorithmic senses, for clarity of communication. But in operation, type-auxiliary operations may be performed either before or after normal inside operations. For example, program code files can be formatted (a type-auxiliary operation) before they are checked in to a repository (an inside operation).

Module Perform User-Auxiliary Operations Means

Module Perform User-Auxiliary Operations Means 128 carries out requests for user-defined CSO operations. User-auxiliary operations may be either inside or outside operations, depending on whether they use collection storage information. Type-auxiliary operations are applied to user-auxiliary operations, to ensure that automatic operations are consistently applied to all target collections that are processed by the collection storage system.

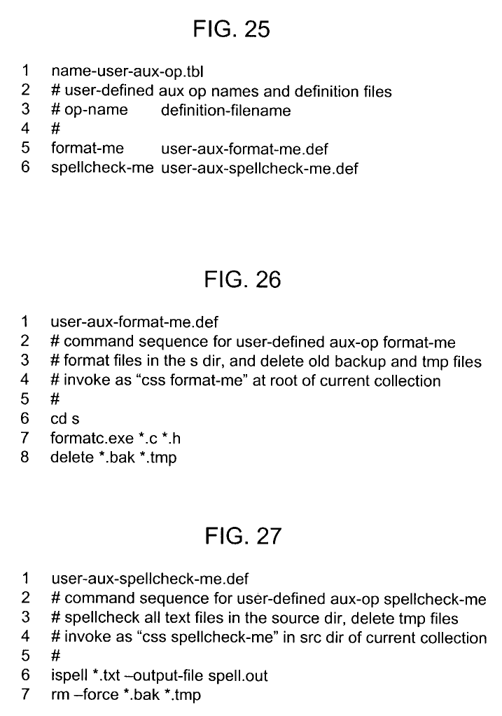

FIG. 25 shows a name lookup table for “user-auxiliary” operations that extend the functionality of a collection storage system. Suppose that an incoming collection storage operation request is for a user-auxiliary operation called “format-me.” Perform User-Auxiliary Operations Means 128 looks up “format-me” in FIG. 25 Line 5 Column 1 of the name table, to obtain a definition filename “user-aux-format-me.def.”

FIG. 26 shows a user-auxiliary definition file for a user-auxiliary operation called “format-me.” Line 6 shows a command line that invokes a program to format all C program code and C header files in the current directory. Line 7 shows a command line that deletes all backup and temporary files in the current directory. In operation, Perform User-Auxiliary Operations Means 128 executes these commands on target collections, thereby formatting files and deleting unwanted files in the collections.

FIG. 27 shows a user-auxiliary definition file for a user-auxiliary operation called “spellcheck-me.” Line 5 shows a command line that invokes a program for spell checking text files. Line 6 shows a command line that invokes a program that removes (deletes) unwanted backup and temporary files. In operation, Perform User-Auxiliary Operations Means 128 executes these commands on target collections, thereby checking for spelling errors and removing unwanted files in the collections.

Ignoring Files In Collection Storage Operations

Software developers like to keep authoritative source trees in repositories “clean” of unwanted “junk” files that clutter up the repository. Junk files consist of backup files, temporary working files, and various other working files that are created during software development activities.

The typical way of solving this problem is for developers to manually delete unwanted junk files before performing checkin operations that copy unwanted files into the authoritative repository. But collection storage systems provide a better way of avoiding junk files.

Collection storage systems, because they work with collections and collection views, have the ability to recognize and ignore junk files when performing inside collection storage operations.

As one example, collection type definitions can define lists of filenames, suffixes, or other matching criteria for use in recognizing (and ignoring) unwanted files and directories. This type of list is called an “ignore list.” Ignore lists that are defined by collection type definitions are collection type dependent ignore lists, because each collection type can ignore a different set of files.

As a second example, a global ignore list can also be defined for the whole collection storage system.

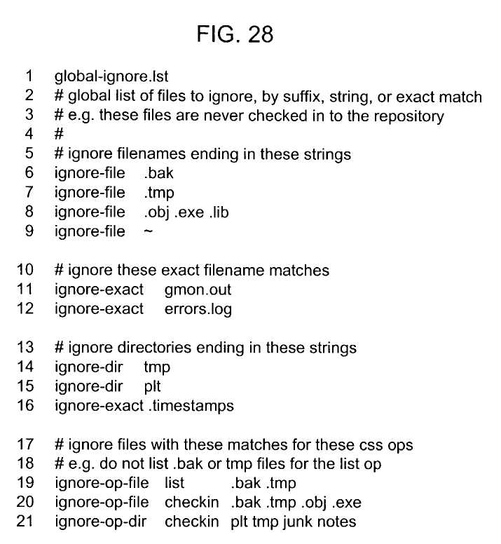

FIG. 28 shows an example global ignore list for a collection storage system. Lines 5-9 show statements that specify to ignore filenames that end in particular character sequences. Lines 10-12 show statements that specify to ignore filenames that exactly match particular filenames. Lines 13-16 show statements that ignore directories.

FIG. 28 Lines 17-21 show ignore list statements that are limited to particular operation names, making it possible to ignore different files for different collection storage operations. For example, Line 19 specifies that for a “list” operation Column 2, filenames ending in “.bak” and “.tmp” should be ignored.

Ignore lists are very useful in practice, because they free developers from having to worry about cleaning up their local source trees before every checkin operation.

Platform Dependent Auxiliary Operations

Platform dependent auxiliary operations enable people to specify different implementations of the same operation for different platforms. This is a useful thing to do because software tools and syntaxes often vary among platforms.

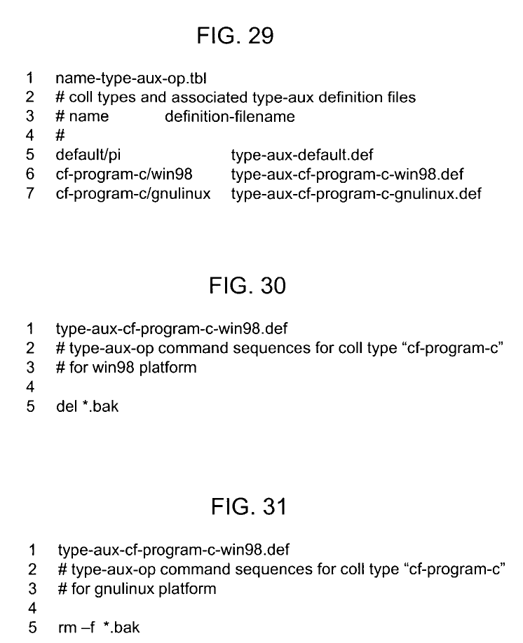

FIG. 29 shows a name lookup table that contains platform-dependent type-auxiliary operations that extend the functionality of a collection storage system. Platform dependence is indicated by a string comprised of a slash “/” character followed by a user-defined name of a computing platform. For example, “/win98” and “/gnulinux” are user-defined (non-trademarked) platform specifiers. Other syntaxes are possible.

FIG. 29 Line 5 shows a platform specifier “/pi” that means “platform independent,” indicating suitability for all platforms. Line 6 shows a platform dependent auxiliary operation name for a “win98” platform. Line 7 shows the same operation name, but for a “gnulinux” platform.

Note that the definition filenames in Lines 6-7 Column 2 are different. They point to different, platform-dependent implementations of the auxiliary operation.

FIG. 30 shows a platform dependent implementation of a type-auxiliary operation for collections of type “cf-program-c” and platform “win98.” FIG. 30 Line 5 invokes a platform dependent program to delete backup files.

FIG. 31 shows a platform dependent implementation of a type-auxiliary operation for collections to type “cf-program-c” and platform “gnulinux.” FIG. 31 Line 5 invokes a platform dependent program to delete backup files.

Conclusion

The present Collection Storage System invention has many practical applications in the technological arts. It enables people and programs to manage the evolution of collections and collection views, using advanced collection storage operations.

It provides practical solutions to seven important problems faced by people who work with groups of related collections. The problems are: (1) the Collection Storage System Problem, (2) the Collection Target Selection Problem, (3) the Collection Outside Operation Problem, (4) the Collection Inside Operation Problem, (5) the Collection Type Auxiliary Operation Problem, (6) the Collection User Auxiliary Operation Problem, and (7) the Platform Dependent Operation Problem.

The present Collection Storage System invention enables people and programs to perform advanced collection storage operations on collections and collection views, using inventive structures that were not previously known to the art.

Ramifications

Although the foregoing descriptions are specific, they should be considered as example embodiments of the invention, and not as limitations of the invention. Many other possible ramifications can be imagined within the teachings of the disclosures made here.

General Software Ramifications

The foregoing disclosure has recited particular combinations of program architecture, data structures, and algorithms to describe preferred embodiments. However, those of ordinary skill in the software art can appreciate that many other equivalent software embodiments are possible within the teachings of the present invention.

As one example, data structures have been described here as coherent single data structures for convenience of presentation. But information could also be spread across a different set of coherent data structures, or could be split into a plurality of smaller data structures for implementation convenience, without loss of purpose or functionality.

As a second example, particular software architectures have been presented here to strongly associate primary algorithmic functions with primary modules in the software architectures. However, because software is so flexible, many different associations of algorithmic functionality and module architectures are also possible, without loss of purpose or technical capability. At the under-modularized extreme, all algorithmic functionality could be contained in one big software module. At the over-modularized extreme, each tiny algorithmic function could be contained in a separate little software module. Program modules could be contained in one executable, or could be implemented in a distributed fashion using client-server architectures and N-tier application architectures, perhaps involving application servers and servlets of various kinds.

As a third example, particular simplified algorithms have been presented here to generally describe the primary algorithmic functions and operations of the invention. However, those skilled in the software art know that other equivalent algorithms are also easily possible. For example, if independent data items are being processed, the algorithmic order of nested loops can be changed, the order of functionally treating items can be changed, and so on.

Those skilled in the software art can appreciate that architectural, algorithmic, and resource tradeoffs are ubiquitous in the software art, and are typically resolved by particular implementation choices made for particular reasons that are important for each implementation at the time of its construction. The architectures, algorithms, and data structures presented in this disclosure comprise one such implementation, which was chosen to emphasize conceptual clarity.

From the above, it can be seen that there are many possible equivalent implementations of almost any software architecture or algorithm. Thus when considering algorithmic and functional equivalence, the essential inputs, outputs, associations, and applications of information that truly characterize an algorithm should be considered. These characteristics are much more fundamental to software inventions than are flexible architectures, simplified algorithms, or particular organizations of data structures.

Means For Storing and Retrieving Information

The foregoing disclosure used simple text files to illustrate structured tables of information, but other implementations are also possible. For example, all software means for retrieving information from the simple text files shown here might also be implemented to retrieve information from a relational database, or from a Collection Knowledge System (see the section on related patent applications at the beginning of this document).

Collection Enabled Configuration Management Systems

FIGS. 16-17 show how a prior art configuration management system could be converted into a collection-aware collection storage system by the addition of a Collection Storage Operation Manager 120 as described by the present invention. FIG. 17 emphasizes the difference between non-collection operations (Do Non-Collection Operations Means 112) and collection-aware collection storage operations (Collection Storage Operation Manager Means 120).

One possible approach for adding collection support to an existing configuration management system is to store the identity and location of collections in a relational database that is accessible by the prior art system. This would minimize the code changes required for the addition, because the prior art system would not have to search its internal file storage and versioning structures for collection specifier files. Instead, the location of collection specifier files would be specified in relational database tables. This approach might be best for prior art configuration management systems that have complex internal file storage structures that cannot easily be searched in situ.

Another approach is to store collections in the normal way, as hierarchical source trees. In this case, the prior art system would need to traverse its hierarchical file system structure to dynamically locate stored collections, perhaps with the help of a Collection Recognizer.

Other approaches are also possible within the teachings of the present invention, such as using flat text files, binary random access files, or object-oriented databases instead.

Select Target Collections Means

Module Select Target Collections Means FIG. 18 122 determines a set of target collections for use in collection storage operations. Selections can be accomplished in several ways. Target collections can be explicitly named by a collection storage operation request. Or match criteria can be provided to match particular inside collection attributes, such as collection types. Or collection views can be expanded to include more collections in the target set. Combinations of the above are possible. For example, a request might explicitly specify a collection, request expansion of collection views within that collection, and then provide collection-type matching criteria to select collections from the expanded set.

In general, target selection can be achieved in many ways, using none, any, or all of the inside collection information and collection view information provided by Get Collection Storage Operation Information Means FIG. 18 123.

Practical Applications

The present Collection Storage System invention has many practical applications in the technical arts. For example, configuration management systems and automated software build systems could use Collection Storage Systems to enable people to conveniently manage the storage and evolution of collections and collection views.

Scope

The full scope of the present invention should be determined by the accompanying claims and their legal equivalents, rather than from the examples given in the specification.

I claim:

1. A Collection Storage System process for managing the storage and evolution of collections of computer files by performing collection storage operations on collections and collection views, to be performed on or with the aid of a computer, comprising the following steps:
(a) receiving a request to perform a collection storage operation on a collection,
(b) performing said collection storage operation on said collection, and
(c) returning results of said collection storage operation to the request originator,
wherein collections are comprised of collection specifiers, including collection type indicators, and optional collection contents, and wherein collection storage information is comprised of collection information and collection view information, and wherein collection storage operations are comprised of collection-aware operations for managing the storage and evolution of collections,
thereby solving the Collection Storage System Problem, solving the Collection Outside Operation Problem, and improving the productivity of people that work with collections and collection views.

2. The process of claim 1, wherein
(a) said step of performing a collection storage operation uses collection storage information to select a set of target collections,
thereby solving the Collection Target Selection Problem, and thereby improving human productivity by enabling programs to select sets of target collections in ways that were not previously known to the art.

3. The process of claim 1, wherein
(a) said step of performing a collection storage operation uses collection storage information to perform said collection storage operation,
thereby solving the Collection Inside Operation Problem, and thereby improving human productivity by providing application programs with detailed attribute-value type definition information for manipulating collections in more advanced ways than were previously known to the art.

4. The process of claim 1, further comprising
(a) performing an auxiliary collection storage operation on said collection, according to the collection type of said collection, using collection storage information,
thereby solving the Collection Type Auxiliary Operation Problem, and thereby improving human productivity by automatically applying auxiliary operations to collections, according to their collection types, in a consistent manner that requires no additional human effort.

5. The process of claim 1, wherein
(a) said step of performing a collection storage operation performs a user-defined auxiliary operation on said collection, using collection storage information,
thereby solving the Collection User Auxiliary Operation Problem, and thereby improving human productivity by enabling people to extend the functional capabilities of a collection storage system to perform useful custom operations determined by users of the system.

6. The process of claim 1, wherein
(a) said step of performing a collection storage operation uses an ignore list means to ignore files or directories while performing said operation,
thereby enabling people and programs to ignore junk files within collections while performing collection storage operations.

7. The process of claim 1, wherein
(a) said step of performing a collection storage operation uses platform dependent auxiliary operations to perform different operations on different platforms,
thereby solving the Platform Dependent Operation Problem, and enabling people and programs to vary the implementation of auxiliary operations according to computing platform.

8. A programmable Collection Storage System device for managing the storage and evolution of collections of computer files by performing collection storage operations on collections and collection views, whose actions are directed by software executing a process comprising the following steps:
(a) receiving a request to perform a collection storage operation on a collection,
(b) performing said collection storage operation on said collection, and
(c) returning results of said collection storage operation to the request originator,
wherein collections are comprised of collection specifiers, including collection type indicators, and optional collection contents, and wherein collection storage information is comprised of collection information and collection view information, and wherein collection storage operations are comprised of collection-aware operations for managing the storage and evolution of collections,
thereby solving the Collection Storage System Problem, solving the Collection Outside Operation Problem, and improving the productivity of people that work with collections and collection views.

9. The programmable device of claim 8, wherein
(a) said step of performing a collection storage operation uses collection storage information to select a set of target collections,
thereby solving the Collection Target Selection Problem, and thereby improving human productivity by enabling programs to select sets of target collections in ways that were not previously known to the art.

10. The programmable device of claim 8, wherein
(a) said step of performing a collection storage operation uses collection storage information to perform said collection storage operation,
thereby solving the Collection Inside Operation Problem, and thereby improving human productivity by providing application programs with detailed attribute-value type definition information for manipulating collections in more advanced ways than were previously known to the art.

11. The programmable device of claim 8, further comprising
(a) performing an auxiliary collection storage operation on said collection, according to the collection type of said collection, using collection storage information,
thereby solving the Collection Type Auxiliary Operation Problem, and thereby improving human productivity by automatically applying auxiliary operations to collections, according to their collection types, in a consistent manner that requires no additional human effort.

12. The programmable device of claim 8, wherein
(a) said step of performing a collection storage operation performs a user-defined auxiliary operation on said collection, using collection storage information,
thereby solving the Collection User Auxiliary Operation Problem, and thereby improving human productivity by enabling people to extend the functional capabilities of a collection storage system to perform useful custom operations determined by users of the system.

13. The programmable device of claim 8, wherein
(a) said step of performing a collection storage operation uses an ignore list means to ignore files or directories while performing said operation,
thereby enabling people and programs to ignore junk files within collections while performing collection storage operations.

14. The programmable device of claim 8, wherein
(a) said step of performing a collection storage operation uses platform dependent auxiliary operations to perform different operations on different platforms,
thereby solving the Platform Dependent Operation Problem, and enabling people and programs to vary the implementation of auxiliary operations according to computing platform.

15. A computer readable memory, encoded with data representing a Collection Storage System computer program, that can be used to direct a computer when used by the computer, comprising:
(a) means for receiving a request to perform a collection storage operation on a collection,
(b) means for performing said collection storage operation on said collection, and
(c) means for returning results of said collection storage operation to the request originator,
wherein collections are comprised of collection specifiers, including collection type indicators, and optional collection contents, and wherein collection storage information is comprised of collection information and collection view information, and wherein collection storage operations are comprised of collection-aware operations for managing the storage and evolution of collections,
thereby solving the Collection Storage System Problem, solving the Collection Outside Operation Problem, and improving the productivity of people that work with collections and collection views.

16. The computer readable memory of claim 15, wherein
(a) said means for performing a collection storage operation uses collection storage information to select a set of target collections,
thereby solving the Collection Target Selection Problem, and thereby improving human productivity by enabling programs to select sets of target collections in ways that were not previously known to the art.

17. The computer readable memory of claim 15, wherein
(a) said means for performing a collection storage operation uses collection storage information to perform said collection storage operation,
thereby solving the Collection Inside Operation Problem, and thereby improving human productivity by providing application programs with detailed attribute-value type definition information for manipulating collections in more advanced ways than were previously known to the art.

18. The computer readable memory of claim 15, further comprising
(a) means for performing an auxiliary collection storage operation on said collection, according to the collection type of said collection, using collection storage information,
thereby solving the Collection Type Auxiliary Operation Problem, and thereby improving human productivity by automatically applying auxiliary operations to collections, according to their collection types, in a consistent manner that requires no additional human effort.

19. The computer readable memory of claim 15, wherein
(a) said means for performing a collection storage operation performs a user-defined auxiliary operation on said collection, using collection storage information,
thereby solving the Collection User Auxiliary Operation Problem, and thereby improving human productivity by enabling people to extend the functional capabilities of a collection storage system to perform useful custom operations determined by users of the system.

20. The computer readable memory of claim 15, wherein
(a) said means for performing a collection storage operation uses an ignore list means to ignore files or directories while performing said operation,
thereby enabling people and programs to ignore junk files within collections while performing collection storage operations.
